(19) United States
(12) Patent Application Publication
(10) Pub. No.: US 2026/0089752 A1
(43) Pub. Date: Mar. 26, 2026

(54) HIERARCHICAL REINFORCEMENT LEARNING FOR NEXT GENERATION OF MULTI-AP COORDINATED SPATIAL REUSE

(71) Applicants: SONY GROUP CORPORATION, Tokyo (JP); SONY CORPORATION OF AMERICA, New York, NY (US)

(72) Inventors: Ziru Chen, San Jose, CA (US); Salvatore Talarico, Los Gatos, CA (US); Qing Xia, San Jose, CA (US)

(73) Assignees: SONY GROUP CORPORATION, Tokyo (JP); SONY CORPORATION OF AMERICA, New York, NY (US)

(21) Appl. No.: 19/307,529

(22) Filed: Aug. 22, 2025

Related U.S. Application Data
(60) Provisional application No. 63/697,332, filed on Sep. 20, 2024.

(51) Int. Cl. H04W 74/04; G06N 7/01; H04W 24/02; H04W 84/12

(52) U.S. Cl. CPC H04W 74/04; G06N 7/01; H04W 24/02; H04W 84/12

(57) ABSTRACT

Multiple Access Point Coordination (MAPC) is directed to enhance WiFi performance by enabling a set of Access Points (APs) to coordinate with each other through advanced coordinating schemes to reduce inter-AP contention and congestion. A process framework is described which facilitates coordination across multiple-APs using Coordinated Spatial Reuse (C-SR), that reciprocally adjust their scheduling strategy, power control and link adaptation to meet specific Quality of Service (QoS) requirements. A two-layer Multi-Armed Bandit (MAB) approach is described, which also preserves fair use of resources across all nodes. The validity of this approach is confirmed by system level simulations, which validate the improved efficiency in terms of sum-throughput, as well as enhanced fairness.

### CROSS-REFERENCE TO RELATED APPLICATIONS

This application claims priority to, and the benefit of, U.S. provisional patent application Ser. No. 63/697,332 filed on Sep. 20, 2024, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to WiFi networks, and more particularly to multiple access point (AP) coordination between multiple APs.

### 2. Background Discussion

As the number of APs in a given portion of a wireless network increases, the limited availability of frequency channels can lead to increased levels of contention and interference, thereby compromising the reliability of WiFi services.

Accordingly, a need exists for wireless protocols which can fairly coordinate APs to reduce inter-AP contention and congestion, while increasing the ability to attain desired Quality-of-Service (QoS) goals. The present disclosure fulfills that need and provides additional benefits over existing systems.

### BRIEF SUMMARY

A wireless protocol for stations operating in a wireless communications network, or portion thereof, which fairly coordinate communication resources across an increased density of AP stations while controlling operations of other STAs in that area. Hierarchical form of Reinforcement Learning (RL) is utilized for performing Coordinated-Spatial Reuse (C-SR). In a region of the WLAN, one AP serves as a transmission initiator, referred to as a ‘sharing AP’. The sharing AP is establishes coordination within a set of APs which serve as followers, referred to as ‘shared APs’.

Multiple Access Point Coordination (MAPC) is performed in which sharing AP and the shared APs, within the WLAN or portion of the WLAN, coordinate with each other to negotiate use of radio resources in establishing a transmitting power as well as a modulation and coding scheme (MCS) for each AP associated to each transmission link. The apparatus and method provides a reduction of inter-AP contention and congestion, and allows obtaining higher Quality-of-Service (QoS) levels.

In at least one embodiment, the Modulation and Coding Scheme (MCS) comprises a coordinated-spatial reuse (CSR) mechanism with a two layer Multiple-Armed Bandit (MAB) approach to jointly tune transmission scheduling and transmit power.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a block diagram of communication station hardware, according to at least one embodiment of the present disclosure.

FIG. 2 is a network topology diagram by way of example and not limitation.

FIG. 3 is a block diagram of the disclosed MAPC framework, according to at least one embodiment of the present disclosure.

FIG. 4 is a flow diagram of general steps in performing hierarchical reinforcement learning for a next generation of multiple AP coordinated spatial reuse, according to at least one embodiment of the present disclosure.

FIG. 5 is a plot of simulated normalized rewards over time, for a weighted sum and for a proportional sum, according to at least one embodiment of the present disclosure.

FIG. 6 is a graph of simulated sum data rate, showing an effective data rate over time for a single transmitter as well as for various Exploration and Exploitation situations, according to at least one embodiment of the present disclosure.

FIG. 7 is a bar graph of simulated total throughput of all APs, showing plots for each of the six APs in a simulation, according to at least one embodiment of the present disclosure.

### DETAILED DESCRIPTION

### 1. Introduction

Over the past two decades Wi-Fi technology has consistently advanced to meet the needs of various applications by integrating state-of-the-art technologies and features to provide progressively higher transmission capacities and lower latency. Beyond traditional Internet and video applications, present day Wi-Fi networks are expected to seamlessly integrate with the Internet of Things (IoT), healthcare, and virtual/augmented reality (VR/AR) applications. This convergence introduces new challenges, such as accommodating novel transmission requirements, managing higher device densities, and ensuring optimal energy efficiency. To address these demands, a common strategy has been proposed for increasing the density of Access Points (APs) within a given area, thus allowing devices to achieve higher Signal-to-Noise Ratio (SNR) levels and, consequently, higher transmission rates.

However, as the number of APs in a given area increases, the limited availability of resources (frequency channels, resource units (RUs)) can lead to increased levels of contention and interference, thereby compromising the reliability of the WiFi services. This approach can also lead to uneven sharing of radio resources across all nodes, whereby some Stations (STAs) could be subject to data starvation, when given an unfairly low percentage of Transmission Opportunities (TXOPs), thus degrading the user experience as well as overall network performance.

Currently, the IEEE working group is seeking to enhance specifications for Wireless Local-Area Networks (WLAN) in an upcoming Wi-Fi 8 specification. One of the proposed changes will be to mitigate high contention levels in dense Wi-Fi environments by implementing coordinated transmission strategies among multiple APs, such as Spatial Reuse (SR). This type of Multiple Access Point Coordination (MAPC) scheme allows a set of APs to coordinate with each other and negotiate proper use of the radio resources, such as by using specific Resource Units (RUs) for each associated STA, while the transmit power and the Modulation and Coding Scheme (MCS) in the AP is associated to each transmission link, toward reducing inter-AP contention and congestion, and simultaneously allowing the network to meet certain Quality-of-Service (QoS) requirements. Additionally, the association among APs and STAs can be managed so as to improve both load balancing and fairness.

Considering that this is a multi-dimensional problem, classical approaches may lead to high overhead and long convergence times due to the necessary negotiations to be performed across the coordinating APs, and requires complex solutions in order to properly optimize the network across all the parameters which are in play.

In particular, the key contribution of the present disclosure employing tools from the discipline of Machine Learning (ML) to design a framework to address the aforementioned challenges, as described in a novel MAPC framework, which addresses Coordinated-Spatial Reuse (C-SR) using a two layer Multi-Armed Bandit (MAB) approach to jointly tune scheduling and transmit power, and the proper MCS of the coordinating APs toward achieving specific QoS requirements associated to each link. The network is optimized by introducing a new metric, which aims at maximizing network data rate, while ensuring the radio resources are always distributed homogeneously across all nodes so as to preserve fairness, and provide improved load balancing.

### 2. Related Work

This section provides to the best of the authors' knowledge a brief review of studies conducted on C-SR for WLAN and the use of ML in this context. In an article [P. Imputato, S. Avallone, M. Smith, D. Nunez, and B. Bellalta, “Beyond Wi-Fi 7: Spatial reuse through multi-ap coordination,” Computer Networks, vol. 239, p. 110160, 2024], the authors introduce a C-SR interference model and present a strategy for estimating groups of APs that can successfully transmit simultaneously and which leverage on exchanging information across APs. In another article [D. Nunez, M. Smith, and B. Bellalta, “Multi-ap coordinated spatial reuse for wi-fi 8: Group creation and scheduling,” in 2023 21st Mediterranean Communication and Computer Networking Conference (MedComNet). IEEE, 2023, pp. 203-208], the authors focused on the problem of creating multi-AP groups that can transmit simultaneously to leverage spatial reuse opportunities, and studied different scheduling algorithms to determine which groups will transmit at every MAPC transmission. In another article [J. Haxhibeqiri, X. Jiao, X. Shen, C. Pan, X. Jiang, J. Hoebeke, and I. Moerman, “Coordinated spatial reuse for Wi-Fi networks: A centralized approach,” in 2024 IEEE 20th International Conference on Factory Communication Systems (WFCS). IEEE, 2024], the authors proposed a centralized C-SR algorithm that determines the transmit powers of the concurrent AP transmitters based on calculated interference levels in the main receiver.

A number of other authors have provided comprehensive system level evaluations for C-SR in order to demonstrate the potential benefits of this coordinating scheme.

For instance, the work in an article [S. V. Vatsa, A. GP, R. Roy, S. Anand, A. Kumar, and J. Kuri, “Multi-AP coordination with centralized overlay time-sliced scheduling in WiFi network,” in 2024 16th International Conference on Communication Systems NETworkS (COMSNETS), 2024, pp. 276-278] highlights the advantages of using C-SR when this is combined with proportional fair scheduling for interference mitigation.

In another article [D. Nunez, F. Wilhelmi, S. Avallone, M. Smith, and B. Bellalta, “TXOP sharing with coordinated spatial reuse in multi-AP cooperative IEEE 802.11 be WLANS,” in 2022 IEEE 19th Annual Consumer Communications & Networking Conference (CCNC). IEEE, 2022, pp. 864-870.8], the authors evaluated two coordinated TXOP sharing strategies, where one of which additionally employs C-SR. The evaluations show that by additionally adopting C-SR a significant throughput gain is achievable.

The authors in [K. Aio, Y. Tanaka, R. Hirata, K. Sakoda, T. Handte, D. Ciochina, and M. Abouelseoud, “Coordinated spatial reuse performance analysis,” Doc.: IEEE802-11.-19/1534r1, 2019] have investigated the performance of C-SR by comparing various flavors of this coordinating scheme with legacy Time Division Duplex (TDD) designs where an AP always transmits with maximum transmit power. In this work, results have shown that regardless of the flavor of the coordinating scheme, C-SR always outperforms legacy TDD.

Finally in article [D. Nunez, F. Wilhelmi, L. Galati-Giordano, G. Geraci, and B. Bellalta, “Spatial reuse in IEEE 802.11 bn coordinated multi-AP WLANs: A throughput analysis,” arXiv preprint arXiv:2407.16390, 2024], the authors evaluated the performance of C-SR by considering an implementation of this scheme where channel access and inter-AP communication are performed over-the-air using the Distributed Coordination Function (DCF). In this case, C-SR is shown to achieve significantly higher throughput compared to the baseline. The authors in [Y. Kihira, K. Yamamoto, A. Taya, T. Nishio, Y. Koda, and K. Yano, “Interference-free AP identification and shared information reduction for tabular q-learning-based WLAN coordinated spatial reuse,” IEICE Communications Express, vol. 11, no. 7, pp. 392-397, 2022] propose a method for identifying interference-free APs and a technique for reducing the amount of shared information between coordinated devices using Q-learning. In an article [M. Wojnar, W. Ciezobka, K. Kosek-Szott, K. Rusek, S. Szott, D. Nunez, and B. Bellalta, “IEEE 802.11bn Multi-AP Coordinated Spatial Reuse with Hierarchical Multi-Armed Bandits,” in TODO, 2024], the authors introduce a MAB algorithm to determine the scheduling strategies in a network employing C-SR with the aim to maximize the network's sum data rate.

However, this approach does not guarantee network fairness, and thus cannot guarantee meeting QoS requirements. Moreover, this work does not fully explore the potential impact of power control and link adaptation. In developing the present disclosure no existing studies were found that simultaneously addressed both network fairness and the optimization of the network throughput, nor have they explored how to adjust transmit power and MCS adjustment while considering the network's QoS requirements.

### 3. System Model

This section provides an illustration of the network topology, based on which a novel MAPC framework is developed. After presenting the MAPC model, the problem formulation and the related optimization objective function is formulated.

### 3.A. Hardware Embodiment and Network Topology

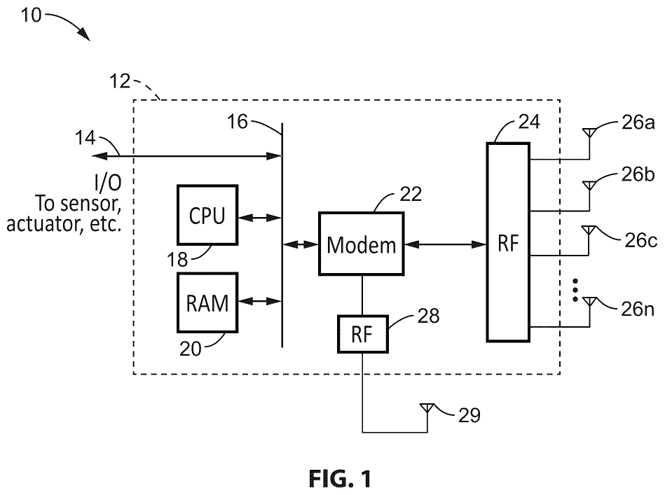

FIG. 1 illustrates an example embodiment 10 of STA hardware configured for executing the protocol of the present disclosure. An external I/O connection 14 preferably couples to an internal bus 16 of circuitry 12 upon which are connected a CPU 18 and memory (e.g., RAM) 20 for executing a program(s) which implements the described communication protocol. The host machine accommodates at least one modem 22 to support communications coupled to at least one RF module 24, 28 each connected to one or multiple antennas 29, 26a, 26b, 26c through 26n. An RF module with multiple antennas (e.g., antenna array) allows performing beamforming during transmission and reception. In this way, the STA can transmit signals using multiple sets of beam patterns.

Bus 14 allows connecting various devices to the CPU, such as to sensors, actuators and so forth. Instructions from memory 20 are executed on processor 18 to execute a program which implements the communications protocol, which is executed to allow the STA to perform the functions of an Access Point (AP) station or a regular station (non-AP STA). It should also be appreciated that the programming is configured to operate in different modes (TXOP holder, TXOP share participant, source, intermediate, destination, first AP, other AP, stations associated with the first AP, stations associated with the other AP, coordinator, coordinatee, AP in an OBSS, STA in an OBSS, and so forth), depending on what role it is performing in the current communication protocol and context.

Thus, the STA HW is shown configured with at least one modem, and associated RF circuitry for providing communication on at least one band. It should be appreciated that the present disclosure can be configured with multiple modems 22, with each modem coupled to an arbitrary number of RF circuits. In general, using a larger number of RF circuits will result in broader coverage of the antenna beam direction. It should be appreciated that the number of RF circuits and number of antennas being utilized is determined by hardware constraints of a specific device. A portion of the RF circuitry and antennas may be disabled when the STA determines it is unnecessary to communicate with neighboring STAs. In at least one embodiment, the RF circuitry includes frequency converter, array antenna controller, and so forth, and is connected to multiple antennas which are controlled to perform beamforming for transmission and reception. In this way the STA can transmit signals using multiple sets of beam patterns, each beam pattern direction being considered as an antenna sector.

In addition, it will be noted that multiple instances of the station hardware, such as shown in this figure, can be combined into a multi-link device (MLD), which typically will have a processor and memory for coordinating activity, although it should be appreciated that these resources may be shared as there is not always a need for a separate CPU and memory for each STA within the MLD.

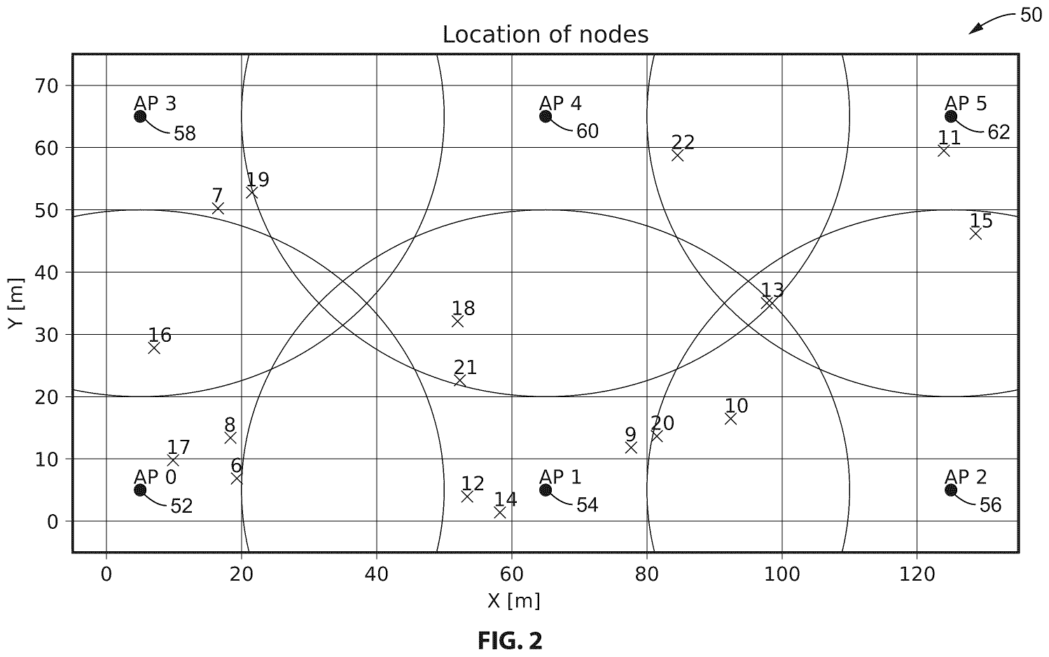

FIG. 2 is an example of a network topology 50 used as an aid to enhance understanding of the present disclosure, which itself is not limited to any specific example. The figure considers a typical indoor office layout where N=6 Basic Service Sets (BSSs) are deployed, with the six associated APs seen as AP0 52, AP1 54, AP2 56, AP3 58, AP4 60, AP5 62, and AP6 64. In this example the associated non-AP stations are shown randomly scattered within the area, each shown with an ‘x’ and associated number (6 through 22).

Assuming that all BSSs have the same capability and coverage area when all the corresponding APs transmit with the same transmitting power. Each BSS is modelled by a circular region with radius ‘r’ where the corresponding AP is located in the center.

In this example, it is assumed that the APs are deployed in a room of size 120 meters by 80 meters, and distributed so that each AP is equally spaced with each other, and they are equally distanced from the perimeter walls of the room as shown in the figure. Also it is being assumed that when APs transmit using the maximum allowed power r=30 meters, and as illustrated in the figure, then the coverage areas of adjacent APs overlap with each other. Without any loss of generality, all devices operates on the same frequency channel and same carrier bandwidth. Each AP is considered to be associated with a given number of non-AP STAs, which are randomly distributed in the whole area [symbol] according to a Poisson Point Process (PPP) with intensity λ, where the total number of deployed STAs is denoted as M and with [symbol] [M]=λ| [symbol] |.

In order to model the channel and penetration losses, the TGac simulation model in spatial channel mode, for Non-Line Of Sight (NLOS) path loss for the residential case is used where the path loss is given by:

$${P}_{L} = 40.05 + 20 {log}_{10} ( \frac{min ( d , {B}_{p} ) {f}_{c}}{2.4} ) + {P}^{′} , \qquad ( 1 )$$

where d represents the distance between devices in meters, f_{c} is the central frequency in GHZ, Bₚ is the breaking point. Also when d≥Bₚ, then P′ is given by P′=35 log₁₀(d/Bₚ); otherwise, P′=0.

For the sake of simplicity, the assumption is that there is an open floor with no walls traversing the area in either the x-direction or y-direction, and it is assumed that each AP has a full buffer with saturated traffic and unlimited buffer. It should be appreciated that in Wi-Fi discussions, when an AP is said to have a full buffer that means the boundary of the APs buffer is not considered, and thus in the simulation it can have an unlimited number of packets to enqueue.

### 3.B. MAPC Operation Framework

After an initial discovery and pairing phase, which is outside the scope of this disclosure, coordination is established across a set of APs. One of the coordinating APs serves as the transmission initiator, known as the sharing AP, while the other coordinating APs serve as followers and are referred to herein as ‘shared APs’. For the sake of providing a simple example, the selection of the sharing AP among the coordinating set of APs is exemplified as being performed in a round-robin fashion, or other selection criterion that preferable involves taking turns in an equitable manner, and the selection is performed for every Transmission Opportunity (TXOP). However, it should be appreciated that other mechanisms may be utilized for performing this selection.

Also, it is assumed, by way of example and not limitation, that each AP may only serve a single non-AP-STA per each TXOP. Coordination among all coordinating APs can be enhanced using a central controller (local or remote), that can be either a physical entity to which all APs must be connected through a wireless or fiber backhaul, or a logical entity collocated within any of the APs, which is responsible (in charge of) directing coordination among APs and performing related (associated) resource management.

In the remainder of the discussion, the index of the sharing AP is denoted as ‘x’ and the associated non-AP-STA, which is scheduled during a specific TXOP is denoted as ‘y’. Once the sharing AP and the scheduled non-AP-STA among the associated non-AP-STAs are selected, the coordinating APs follow the instructions provided by the central controller in terms of either scheduling and/or resource allocation. Specifically, the central controller communicates several elements of control information to the coordinating set of APs, which include sharing/shared AP information, STA association, transmission power, Modulation Coding Scheme (MCS) selection, as well as QoS requirements for all links and to all APs. Once these instructions are communicated, all APs will be aware of their individual scheduling and resource management, and therefore can proceed with transmitting downlink signals during a TXOP.

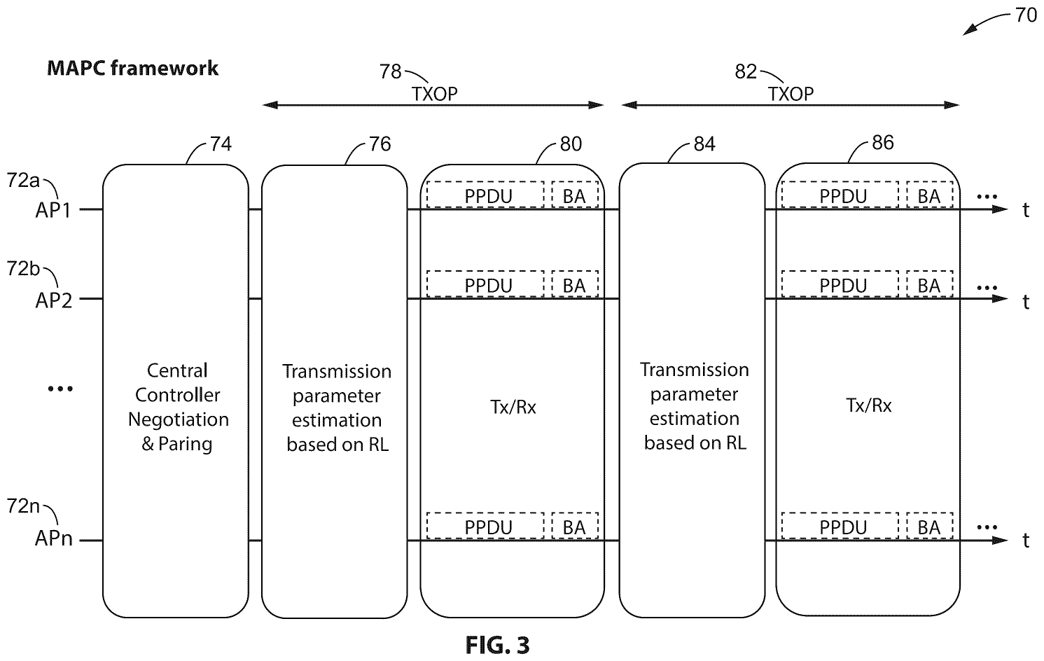

FIG. 3 illustrates an example 70 of the disclosed MAPC framework. A number of APs are shown being involved with AP1 72a, AP2 72b through to APn 72n, with a Central controller 74 configured for performing negotiation and pairing. A quick transmission parameter estimation 76 is performed based on Reinforcement Learning (as described in Section 4), within a first TXOP 78, after which a transmit/receive (Tx/Rx) session 80 is performed with transmissions (PPDUs), receipts and acknowledgements taking place. Subsequent TXOPs 82 also perform the same transmission parameter estimations 84 and Tx/Rx sessions 86.

In order to model power control in the k-th TXOP, the set of transmit powers that can be associated to any AP is denoted as [symbol] , in which the transmit power of AP j during that instance of time is defined as p_{j,k}∈ [symbol] . It is important to note that the transmit power associated to any AP is chosen from a discrete set [symbol] , where [symbol] =[pl₀, pl₁, . . . pl_{d}_{ₜ₋₁}], where pl_{z} is the z-th power level, which is expressed as pl_{z}=(pₘₐₓ−pₘᵢₙ)/dₜ·Z+pₘᵢₙ, where dₜ represents the number of power levels that can be selected by each AP, while pₘₐₓ and pₘᵢₙ. are respectively the maximum and minimum transmit power that can be selected. It should be noted that zero (0) is selected as the transmit power when an AP is not scheduled for transmission during a specific TXOP. As for link adaptation, the set of MCSs defined in the 802.11 specification for 20 MHz channel bandwidth, may be utilized herein assuming convolution codes are utilized as summarized in Table 1.

For all shared APs, the transmit power can be selected from the set {0, [symbol] } since the shared AP may not be arranged for transmission during this TXOP, in which 0 will be selected as the transmit power. The set of MCS indexes (selection strategies) that can be selected during the k-th TXOP is denoted as [symbol] where m_{j,k}∈ [symbol] is the MCS index of AP j at the k-th TXOP.

An association parameter set [symbol] is denoted for the association strategies, in particular, a set which indicates the active non-AP STAs during the k-th TXOP, in which a_{i,j,k}∈ [symbol] denotes the association information between the j-th AP and the i-th non-AP STA during the k-th TXOP. In at least one embodiment it is assumed that each AP can only serve at most one STA at each downlink transmission, the relation

$${\sum }_{i = 1}^{N} {a}_{i , j , k} \leq 1 ,$$

∀_{j,k} should be satisfied. It should be noted that a_{i,j,k}=1 if a transmission occurs between the j-th AP and the i-th non-AP STA during the k-th TXOP, and a_{i,j,k}=0 otherwise.

The QoS requirements of the transmission between the sharing AP and its associated STA is denoted as Q. In this context, the aggregated sum data rate of STA i in the k-th TXOP could be written as:

$${R}_{j , k} = {\sum }_{i = 1}^{D} {r}_{i , j , k} . \qquad ( 2 )$$

where D is the number of non-AP STAs associated with the j-th AP with an active link during the k-th TXOP, and:

$${r}_{i , j , k} = \frac{{L}_{frame} {N}_{i , j , k}}{τ} , \qquad ( 3 )$$

in which L_{frame} is the length of each frame, N_{i,j,k} is the number of frames transmitted between STA i and AP j in the k-th TXOP, and T is the duration of each TXOP. The calculation of the number of frames transmitted in the TXOP is given by:

$${N}_{i , j , k} = \frac{\overline{R} ( {m}_{j , k} ) τ}{{L}_{frame}} \prod [ S I N {R}_{i , j , k} \geq γ ] {P}_{i , j , k}^{success} \qquad ( 4 )$$

where R̅(m_{j,k}) is the achievable rate when the MCS index m_{j,k} is used and the related values are those captured in Table 1, γ is a threshold which is determined based on the Signal to Interferences Plus Noise Ratio (SINR) level, denoted by SINR_{i,j,k}, whether the transmitted frames could be detected, and Π[x] is a function which assumes value 1 if x is true, otherwise it is equal to 0. Furthermore the SINR level is expressed as:

$$S I N {R}_{i , j , k} = \frac{{p}_{j , k} {P}_{{L}_{i , j , k}} {a}_{i , j , k}}{{\sum }_{u \neq i} {\sum }_{v \neq j} {p}_{v , k} {P}_{{L}_{u , v , k}} {a}_{u , v , k} + {σ}^{2}} ,$$

where P_{L}_{_{i,j,k}} indicates the path loss between STA i and AP j during k-th TXOP, σ² denotes the White Gaussian noise.

$${P}_{i , j , k}^{success}$$

is the probability that a frame transmitted specifically with MCS index m_{j,k} could be successfully decoded, and is calculated as:

$${P}_{i , j , k}^{success} = P ( S I N {R}_{i , j , k} \geq X ) \qquad ( 5 )$$

where

$$X \sim 𝒩 ( 𝔼 [ {\overline{S I N R}}_{{m}_{j , k}} ] , {σ}_{m}^{2} )$$

and S̅I̅N̅R̅ₘ_{_{i,k}} in at least one embodiment can be considered the maximum data rate that can be achieved for MCSₘ_{_{i,k}}, while it is more particularly the mean SINR level required to decode a frame transmitted with MCS index mix and the related values are those captured in Table 2.

### 3.C. Problem Formulation

When designing a wireless system, there is an existing trade-off between optimizing the sum data rate of the whole network and ensuring fairness in the allocating resources across all nodes. Thus, to maximize joint performance of sum data rate and fairness, the sum data rate and fairness in an optimization objective function should be jointly considered. One approach is to combine these two objectives (KPIs) into a weighted objective, or use a fairness-aware metric, such as the Proportional Fairness criterion.

(1) Weighted Sum: The objective function is expressed as a weighted sum of the total data rate and a fairness metric, i.e., Jain's fairness index. The relative importance of each aspect can be adjusted by changing the weights.

By denoting α∈[0,1] a weighted parameter is used to balance between maximizing data rate and fairness. The objective function is written as:

$${max}_{𝒫 , 𝒜 , ℳ , Q} α {\sum }_{j = 1}^{{N}_{ap}} {\sum }_{k = 1}^{K} {R}_{j , k} + ( 1 - α ) \cdot f ( R ) \qquad ( 6 )$$

subject to:

$${r}_{y , x , k} \geq Q , ∀ k \qquad ( 7 a )$$

where r_{y,x,k} denotes the data rate of the sharing AP x and its associated STA y at the k-th TXOP. Wherein

$$f ( R ) = \frac{{( {\sum }_{j = 1}^{{N}_{ap}} {\sum }_{k = 1}^{K} {R}_{j , k} )}^{2}}{{\sum }_{j = 1}^{{N}_{ap}} {\sum }_{k = 1}^{K} {R}_{j , k}^{2}} \qquad ( 7 b )$$

represents the Jain's Fairness Index f(R) of all APs. Furthermore, [symbol] ={ [symbol] , ∀k∈[1, K]}, [symbol] ={ [symbol] , ∀k∈[1, K]}, [symbol] ={ [symbol] , ∀k∈[1, K]}, where K is the maximum TXOP duration, and where the granularity of k is 1. It will be noticed that the above objective function is constrained so as to guarantee certain QoS requirements for each transmission between an AP and its associated non-AP STA, where the requirement is denoted as [symbol] .

(2) Proportional Fairness: Proportional fairness aims to balance between maximizing the total data rate and ensuring that the resource allocation is fair to all users by maximizing the sum of logarithms of the data rates.

The objective function for proportional fairness is give by:

$${max}_{𝒫 , 𝒜 , ℳ , Q} {\sum }_{j = 1}^{{N}_{ap}} log ( {\sum }_{k = 1}^{K} {R}_{j , k} ) \qquad ( 8 )$$

$$subject to {r}_{y , x , k} \geq Q , ∀ k . \qquad ( 9 )$$

This function inherently balances maximizing the sum of the data rates while giving diminishing returns to higher rates, which encourages more fair resource allocation among users. In the present disclosure performance is evaluated based on comprehensive comparison with both criterion. It should be noted that the above objective function is constrained so as to guarantee certain QoS requirements for each transmission between an AP and its associated non-AP STA, where the requirement is denoted as [symbol] .

### 4. Disclosed Learning Method

In this disclosure a two-layer (two agent) Reinforcement Learning (RL) process is introduced for addressing the problem at hand of jointly addressing the trade off between sum data rate and fairness in an optimization objective function. The core of RL is the Markov Decision Process (MDP), where the next state is determined solely by the current state and action, without any dependence on past states. An MDP is characterized by a set of states S, actions A, state transition probabilities Pt, and a reward function R; and can be defined as:

$$M = 〈 S , A , {P}_{t} , R 〉 . \qquad ( 10 )$$

The state space is determined by the network topology, which significantly impacts scheduling decisions. The action space is composed of adjustable parameters, such as transmission power [symbol] , association selection [symbol] , MCS [symbol] , and QoS requirements [symbol] , in the relation shown below Eq. 7b. The objective here is to maximize the overall data rate while ensuring fairness, as defined by the reward functions in equations (6) and (8).

Since these reward functions consider long-term fairness, they are evaluated over multiple time slots [symbol] . Updating all parameters only once every [symbol] time slots could result in slow adaptation to dynamic changes. To address this, at least one embodiment of the present disclosure describes a hierarchical (multi-layer) MAB approach, for example having at least an outer and inner layer.

The outer layer MAB process adjusts the target QoS parameters [symbol] between the sharing AP and its associated STA every Tₒᵤₜₑᵣ time slots, balancing data rate maximization and fairness as Equations (6) and (8). The inner layer MAB process, operating at each single time slot, fine-tunes [symbol] , [symbol] , and [symbol] based on the updated QoS targets.

In the outer layer, the agent determines the QoS parameters [symbol] , which are implemented in simulations over a duration of Tₒᵤₜₑᵣ time slots to optimize the reward. The performance results from these simulations are then fed back (feedback) to the agent to inform and refine its subsequent decisions. It is the agent that is performing the reinforcement learning method and providing instructions to the central controller on what is to be performed in the next round.

In the inner layer, for each time slot, a sharing AP and one of its associated STAs are randomly selected for downlink transmission. The first-level agent then selects a subset of shared APs based on the context (chosen AP and STA). Following this, the second-level agent selects, for each AP in the subset, and an associated STA along with its transmission power and MCS. These selected configurations are tested through simulations to maximize the data rate, and the resulting performance metrics are fed back to the agents to guide future decisions.

To encourage exploration during training, in at least one embodiment a noise term is added to each action performed, as sampled from a Gaussian distribution to balance between trying new actions and using known strategies. An action is defined as a decision that the machine learning agent sends to the central controller to guide the transmission protocols. In the execution phase, the model remains static without further updates or reward collection. The noise term can be set to zero, allowing the model to make decisions based solely on the current state in the MAP. If there are changes in the environment, training can be re-initiated to adjust the neural network at predefined intervals.

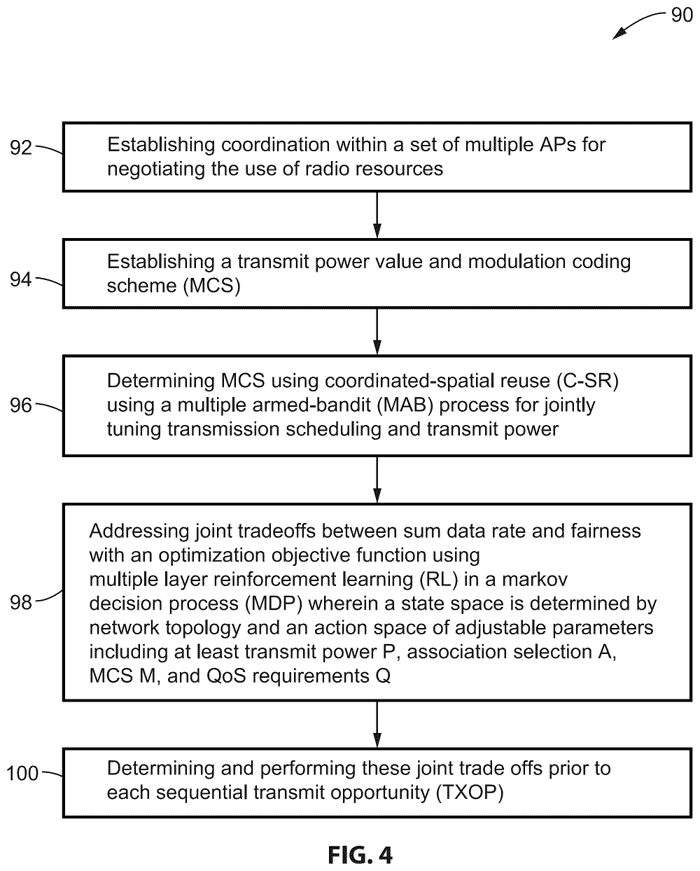

FIG. 4 illustrates an example 90 of the general steps in performing hierarchical reinforcement learning for a next generation of multiple AP coordinated spatial reuse. In block 92 coordination is established within a set of multiple APs for negotiating the use of radio resources, Then in block 94 is shown establishing a transmit power value and Modulation Coding Scheme, which will then be adjusted over time. In block 96 MCS is determined using coordinated-spatial reuse (C-SR) using a Multiple Armed-Bandit (MAB) process for jointly tuning transmission scheduling and transmit power. In block 98 is shown addressing joint tradeoffs between sum data rate and fairness with an optimization objective function using multiple layer Reinforcement Learning (RL) in a Markov Decision Process (MDP) wherein a state space is determined by network topology and an action space of adjustable parameters including at least transmit power P, association selection A, MCS M, and QoS requirements Q. Then in block 100 is seen that these joint trade offs are determined and performed prior to each sequential transmit opportunity (TXOP).

### 5. Simulation Results

In order to deliver a comprehensive performance evaluation, the disclosed process is compared with two other approaches using baseline techniques. A Python-based simulator was thoroughly developed to simulate Wi-Fi network operation, including providing network state information, executing corresponding actions, and tracking network throughput. The proposed algorithm is implemented in a PyTorch framework. The performance results of the proposed two layer MAB algorithm will be illustrated in this section and the pertinent parameters are listed in Table 2. It should be appreciated that the present disclosure is not limited in regard to what simulator or framework is utilized.

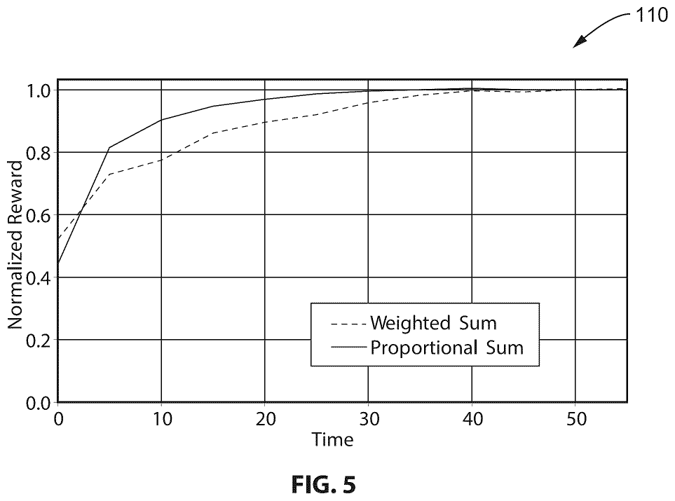

FIG. 5 illustrates a plot 70 of normalized rewards over time, for a weighted sum compared with a proportional sum fairness reward in terms of convergence of the algorithm as a function of time. The figure indicates that the proposed two layer hierarchical MAB algorithm achieves convergence after only a few iterations. This rapid convergence demonstrates that the disclosed mechanism is capable of quickly adapting to, and optimizing, the network parameters, and simultaneously, guaranteeing reliable performance with respect to both rewards. In addition, it can also be seen in the graph that when compared with the weighted sum reward, the proportional sum reward stabilizes substantially faster.

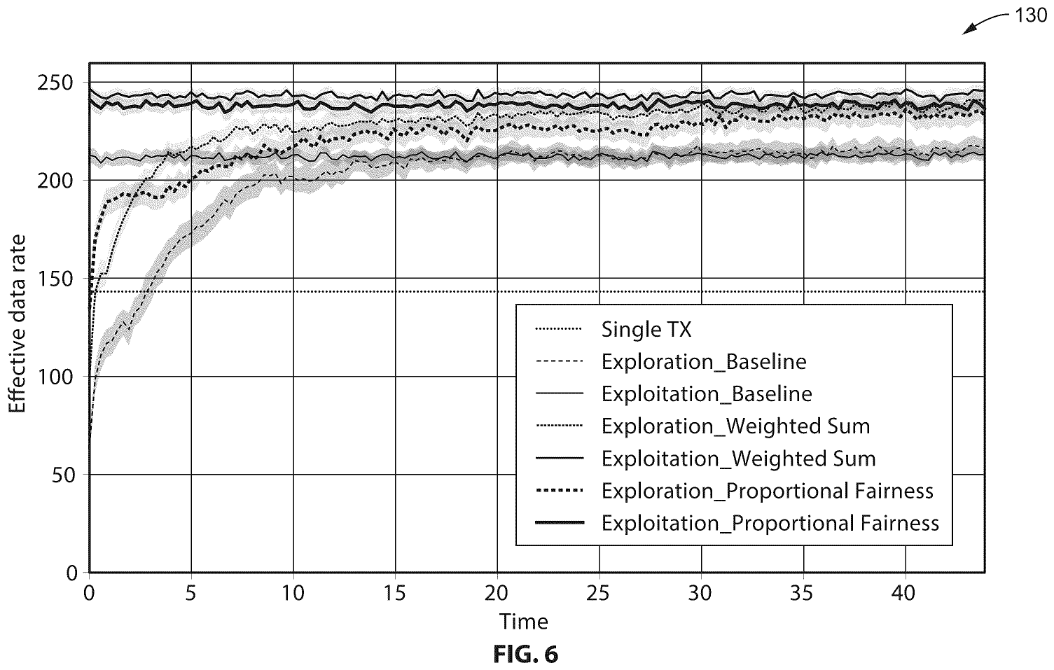

FIG. 6 illustrates a graph 130 of simulated sum data rate, showing plots of effective data rate over time for a single transmitter as well as Exploration_Baseline, Exploitation_Baseline, Exploration_Weighted Sum, Exploitation_Weighted Sum, Exploration_Proportional Fairness, and Exploitation_Proportional Fairness. This aggregated sum data rate over all APs is shown as a function of time, with the figure comparing the performances between the case when a single AP transmits with no MAPC, and difference cases of when MAPC is used. In this case, the baseline mechanism is compared with the disclosed embodiment when the two different rewarding strategies are used. Furthermore, the disclosed method results are provided for each reward strategy introduced in Section 4.

The figure validates the effectiveness of adopting MAPC when C-SR is used, and shows that significant improvement can be achieved by employing such a coordinating scheme. The figure also demonstrates that the proposed solution is able to achieve higher aggregated sum data rates compared to the baseline. In the figure it is also illustrated once again that in terms of reward strategy, the proportional fairness reward allows mechanism to converge more rapidly than the weighted sum reward, while also achieving a slightly higher aggregated sum data rate.

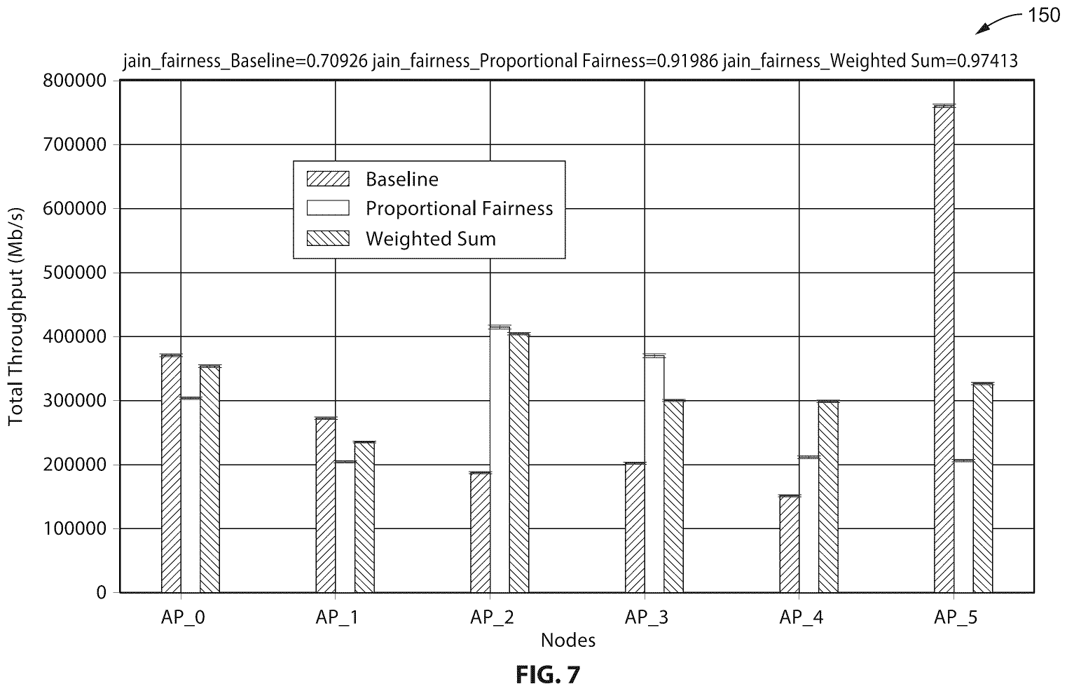

FIG. 7 illustrates a bar graph 150 of simulated total throughput of all APs, showing plots for each of the six APs shown in FIG. 2, showing Baseline, Proportional Fairness, and Weighted Sum. Average throughput was evaluated for each individual AP, in order to show the benefits in terms of fairness of the disclosed embodiment, with average throughput evaluated for each individual AP and determined over 5000 TXOPs. This figure compares the baseline with the teaching of the present disclosure when both the weighted sum and proportional sum fairness reward are used.

In the figure it can be seen that the baseline operation tends to favor the transmission of specific APs. In response to using the present disclosure, there is a more balanced throughput distribution, which is more pronounced when the weighted sum reward is used. When using the Jain's fairness index to quantify fairness, it provides a result value equivalent to 0.709 for the baseline method, 0.92 for the disclosed mechanism used in combination with the proportional fairness reward, and 0.97 when the disclosed mechanism is used in combination with the weighed sum reward.

### 6. Conclusions

The present disclosure describes a novel framework based on a hierarchical RL algorithm with the aim to facilitate coordination across multi-APs when these employ C-SR. The proposed framework provides an efficient solution to jointly tune the coordinating APs' scheduling, and transmit power, but also in selecting the proper MCS so as to achieve specific QoS requirements associated to each link. The network is optimized by introducing two new metrics, which aim at maximizing the network data rate, while ensuring the radio resources are always distributed homogeneously across all nodes so that to preserve fairness, and provide improved load balancing. A system-level simulation campaign has been performed to validate the effectiveness of the proposed solution, which highlights its ability to enhance global throughput and fairness across the network. This innovative framework offers a promising and robust solution for optimizing resource allocation in next-generation Wi-Fi networks, toward paving the way for improved user experiences and more reliable network performance in dense deployment scenarios.

### 7. General Scope of Embodiments

Embodiments of the technology of this disclosure may be described herein with reference to flowchart illustrations of methods and systems according to embodiments of the technology. Embodiments of the technology of this disclosure may also be described with reference to procedures, algorithms, steps, operations, formulae, or other computational depictions, which may be included within the flowchart illustrations or otherwise described herein. It will be appreciated that any of the foregoing may also be implemented as computer program instructions. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula (e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media, or can be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, the terms controller, microcontroller, processor, microprocessor, hardware processor, computer processor, central processing unit (CPU), and computer are used synonymously to denote a device capable of executing the instructions and communicating with input/output interfaces and/or peripheral devices, and that the terms controller, microcontroller, processor, microprocessor, hardware processor, computer processor, CPU, and computer are intended to encompass single or multiple devices, single core and multicore devices, and variations thereof.

From the description herein, it will be appreciated that the present disclosure encompasses multiple implementations of the technology which include, but are not limited to, the following:

A station apparatus for communication in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol for allowing an increased density of access points (APs) within the WLAN, or portion of the WLAN, using hierarchical reinforcement learning for multiple-AP (MAP) coordinated spatial reuse (CSR), comprising: (e) (i) wherein said STA operates in the wireless communications protocol as an access point (AP) STA configured for communicating with other STAs, including both AP STAS and non-AP STAS; (e) (ii) wherein said AP serves as a transmission initiator, as a sharing AP, configured for establishing coordination within a set of APs, wherein each of the other APs on this portion of the WLAN serve as followers, as shared APs; (e) (iii) performing multiple access point coordination (MAPC) in which the said AP, and other APs within the WLAN or portion of the WLAN, operating with this wireless communications protocol, coordinate with each other to negotiate use of radio resources in establishing a transmit power and a modulation and coding scheme (MCS) for each AP associated to each transmission link, for reducing inter-AP contention and congestion, and toward allowing Quality-of-Service (QoS) requirements to be met; (e) (iv) wherein said modulation and coding scheme (MCS) is determined by a two layer multiple-armed bandit (MAB) process in jointly tuning transmissions; (e) (v) determining coordinated-spatial reuse (C-SR) to jointly address a trade off between sum data rate and fairness using an optimization objective function comprising multiple layer reinforcement learning (RL) in a Markov decision process (MDP) characterized by a set of states S, actions A, a reward function R, and transition probabilities Pt, in which a next state of a state space, is determined solely by a current state and action of an action space, to be taken without dependence on past states, and wherein said reward function is evaluated over multiple time periods toward obtaining long-term fairness; (e) (vi) wherein the state space is determined by network topology and the action space having adjustable parameters comprising transmission power P, association selection A, MCS M, and QoS requirements Q, with these joint trade offs performed prior to each transmit opportunity (TXOP); and (e) (vi) whereby communication resources are fairly coordinated across an increased density of AP stations while controlling operations of followers on this portion of the WLAN.

A station apparatus for communication in a wireless network, the apparatus comprising: (a) at least one modem coupled to at least one radio-frequency (RF) circuit, with each RF circuit connected to one or multiple antennas; (b) wherein said station (STA) is configured as a separate STA or as a STA within a multiple-link device (MLD); (c) a processor of said STA; (d) a non-transitory memory storing instructions executable by the processor for wirelessly communicating with other STAs on a IEEE 802.11 wireless local area network (WLAN); and (e) wherein said instructions, when executed by the processor, perform steps of a wireless communications protocol for allowing an increased density of access points (APs) within the WLAN, or portion of the WLAN, using hierarchical reinforcement learning for multiple-AP (MAP) coordinated spatial reuse (CSR), comprising: (e) (i) wherein said STA operates in the wireless communications protocol as an access point (AP) STA configured for communicating with other STAs, including both AP STAs and non-AP STAS; (e) (ii) wherein said AP serves as a transmission initiator, as a sharing AP, configured for establishing coordination within a set of APs, wherein each of the other APs on this portion of the WLAN serve as followers, as shared APs; (e) (iii) performing multiple access point coordination (MAPC) in which the said AP, and other APs within the WLAN or portion of the WLAN, operating with this wireless communications protocol, coordinate with each other to negotiate use of radio resources and specific resource units (RUs) in establishing a transmit power and a modulation and coding scheme (MCS) for each AP associated to each transmission link, for reducing inter-AP contention and congestion, and toward allowing Quality-of-Service (QoS) requirements to be met; and (e) (iv) determining coordinated-spatial reuse (C-SR) to jointly address a trade off between sum data rate and fairness using an optimization objective function comprising multiple layer reinforcement learning (RL) in a Markov decision process (MDP) characterized by a set of states S, actions A, a reward function R, and transition probabilities Pt, in which a next state of a state space, is determined solely by a current state and action of an action space, to be taken without dependence on past states, and wherein said reward function is evaluated over multiple time periods toward obtaining long-term fairness; (e) (v) wherein the state space is determined by network topology and the action space having adjustable parameters comprising transmission power P, association selection A, MCS M, and QoS requirements Q, with these joint trade offs performed prior to each transmit opportunity (TXOP); and (e) (vi) whereby communication resources are fairly coordinated across an increased density of AP stations while controlling operations of followers on this portion of the WLAN.

A method of performing communications in a wireless network, comprising: (a) performing wireless communications between STAs on a IEEE 802.11 wireless local area network (WLAN), following steps of a wireless communications protocol for allowing an increased density of access points (APs) within the WLAN, or portion of the WLAN, using hierarchical reinforcement learning for multiple-AP (MAP) coordinated-spatial reuse (C-SR), comprising: (a) (i) wherein one AP serves as a transmission initiator, which operates as a sharing AP, configured for establishing coordination within a set of APs, wherein each of the other APs on this portion of the WLAN serve as followers, operating as shared APs; (a) (ii) performing multiple access point coordination (MAPC) in which the said AP, and other APs within the WLAN or portion of the WLAN, operating with this wireless communications protocol, coordinate with each other to negotiate use of radio resources in establishing a transmit power and a modulation and coding scheme (MCS) for each AP associated to each transmission link, for reducing inter-AP contention and congestion, and toward allowing Quality-of-Service (QoS) requirements to be met; and (a) (iii) wherein said modulation and coding scheme (MCS) is determined by a two layer multiple-armed bandit (MAB) process in jointly tuning transmissions; (a) (iv) determining coordinated-spatial reuse (C-SR) to jointly address a trade off between sum data rate and fairness using an optimization objective function comprising multiple layer reinforcement learning (RL) in a Markov decision process (MDP) characterized by a set of states S, actions A, a reward function R, and transition probabilities Pt, in which a next state of a state space, is determined solely by a current state and action of an action space, to be taken without dependence on past states, and wherein said reward function is evaluated over multiple time periods toward obtaining long-term fairness; (a) (v) wherein the state space is determined by network topology and the action space having adjustable parameters comprising transmission power P, association selection A, MCS M, and QoS requirements Q, with these joint trade offs performed prior to each transmit opportunity (TXOP); and (a) (vi) whereby communication resources are fairly coordinated across an increased density of AP stations while controlling operations of followers on this portion of the WLAN.

The apparatus or method of any preceding implementation, wherein selection of said sharing AP is configured for equitable sharing of communication resources between multiple APs.

The apparatus or method of any preceding implementation, wherein said equitable sharing of communication resources comprises determining which AP is to be the sharing AP based on a round-robin selecting process.

The apparatus or method of any preceding implementation, wherein coordinating transmission scheduling and transmit power comprises using specific resource units (RUs) for each associated STA.

The apparatus or method of any preceding implementation, wherein both sum data rate and fairness are jointly considered in an optimization objective function.

The apparatus or method of any preceding implementation, further comprising consideration of long-term fairness in reward functions evaluated with respect to time.

The apparatus or method of any preceding implementation, further comprising executing a hierarchical MAB simulation approach in evaluating said reward functions, comprising: (a) adjusting the target quality-of-service (QoS) parameters in an outer layer of the MAB simulation, between the sharing AP and its associated STA, for every Touter time slot, while balancing data rate maximization and fairness; (b) performing an inner layer of the MAB simulation, operating at each single time slot, to fine-tune transmission power (P), association selection (A), and MCS, based on adjusted target QoS; and (c) feeding back performance results from the inner and outer MAB simulations back to inform and refine subsequent coordination decisions.

The apparatus or method of any preceding implementation, wherein for each time slot, the inner layer of the MAB simulation randomly selects a sharing AP and one of its associated STAs for downlink transmission; and selecting a subset of shared APs based on the context of chosen AP and STA, after which for each AP in the subset, an associated STA along with its transmission power and MCS are tested through simulations to maximize data rate, with the resulting performance metrics being fed back to guide future decisions.

The apparatus or method of any preceding implementation, further comprising introducing a noise term into said hierarchical MAB simulations to encourage exploration during training, wherein the noise term is added, then sampled from a Gaussian distribution to balance between trying new actions and using known strategies.

The apparatus or method of any preceding implementation, further comprising said AP and the other APs, within the WLAN or portion of the WLAN, under this wireless communications protocol receive communications from a central controller that is responsible for coordinating all coordinating APs and performing associated resource management among these APs.

The apparatus or method of any preceding implementation, wherein said AP and coordinating APs, within the WLAN or portion of the WLAN, follow the instructions provided by the central controller in their scheduling and/or resource allocation, in response to the central controller communicating several elements of control information to said coordinating APs; and wherein the control information comprises sharing/shared AP information, STA associations, transmission power, MCS selection, and quality-of-service (QoS) requirements for all links and to all APs, whereby all APs within the WLAN or portion of the WLAN are made aware of their individual scheduling and resource management, prior to transmitting downlink signals during a transmit opportunity (TXOP).

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has. a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1
MCS Table for 20 MHz Channels

| MCS Index | | Coding | Data Rate | S̅I̅N̅R̅ |
|---|---|---|---|---|
| (m_{j, k}) | Modulation | Rate | Mb/s, R( ) | (dB) |
| 0 | BPSK | 1/2 | 9 | 10.61 |
| 1 | QPSK | 1/2 | 17 | 10.65 |
| 2 | QPSK | 3/4 | 26 | 10.66 |
| 3 | 16-QAM | 1/2 | 34 | 10.68 |
| 4 | 16-QAM | 3/4 | 52 | 11.15 |
| 5 | 64-QAM | 2/3 | 69 | 15.41 |
| 6 | 64-QAM | 3/4 | 77 | 16.73 |
| 7 | 64-QAM | 5/6 | 86 | 18.09 |
| 8 | 256-QAM | 3/4 | 103 | 21.80 |
| 9 | 256-QAM | 5/6 | 115 | 23.33 |
| 10 | 1024-QAM | 3/4 | 129 | 29.78 |
| 11 | 1024-QAM | 5/6 | 143 | 31.75 |
| 12 | 4096-QAM | 3/4 | 155 | 33.74 |
| 13 | 4096-QAM | 3/4 | 172 | 35.56 |
| 14 | BPSK-DCM-DUP | 1/2 | N/A | N/A |
| 15 | BPSK-DCM | 1/2 | 4 | 10.61 |

TABLE 2
Simulation Parameters

| Parameter | Value |
|---|---|
| λ | 0.002 |
| pₘₐₓ[dB] | 20 |
| pₘᵢₙ[dB] | 10 |
| Bₚ[meter] | 3 |
| f_{c}[GHz] | 2.4 |
| L_{frame}[byte] | 1500 |
| ${σ}_{m}^{2}$ | 2 |
| α | 0.02 |
| τ | 5.484e⁻³ |

What is claimed is:

1. A station apparatus for communication in a wireless network, the apparatus comprising:
(a) at least one modem coupled to at least one radio-frequency (RF) circuit, with each RF circuit connected to one or multiple antennas;
(b) wherein said station (STA) is configured as a separate STA or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol for allowing an increased density of access points (APs) within the WLAN, or portion of the WLAN, using hierarchical reinforcement learning for multiple-AP (MAP) coordinated spatial reuse (CSR), comprising:
(i) wherein said STA operates in the wireless communications protocol as an access point (AP) STA configured for communicating with other STAs, including both AP STAs and non-AP STAS;
(ii) wherein said AP serves as a transmission initiator, as a sharing AP, configured for establishing coordination within a set of APs, wherein each of the other APs on this portion of the WLAN serve as followers, as shared APs;
(iii) performing multiple access point coordination (MAPC) in which the said AP, and other APs within the WLAN or portion of the WLAN, operating with this wireless communications protocol, coordinate with each other to negotiate use of radio resources in establishing a transmit power and a modulation and coding scheme (MCS) for each AP associated to each transmission link, for reducing inter-AP contention and congestion, and toward allowing Quality-of-Service (QoS) requirements to be met;
(iv) wherein said modulation and coding scheme (MCS) is determined by a two layer multiple-armed bandit (MAB) process in jointly tuning transmissions;
(v) determining coordinated-spatial reuse (C-SR) to jointly address a trade off between sum data rate and fairness using an optimization objective function comprising multiple layer reinforcement learning (RL) in a Markov decision process (MDP) characterized by a set of states S, actions A, a reward function R, and transition probabilities Pt, in which a next state of a state space, is determined solely by a current state and action of an action space, to be taken without dependence on past states, and wherein said reward function is evaluated over multiple time periods toward obtaining long-term fairness;
(vi) wherein the state space is determined by network topology and the action space having adjustable parameters comprising transmission power P, association selection A, MCS M, and QoS requirements Q, with these joint trade offs performed prior to each transmit opportunity (TXOP); and
(vii) whereby communication resources are fairly coordinated across an increased density of AP stations while controlling operations of followers on this portion of the WLAN.

2. The apparatus of claim 1, wherein selection of said sharing AP is configured for equitable sharing of communication resources between multiple APs.

3. The apparatus of claim 2, wherein said equitable sharing of communication resources comprises determining which AP is to be the sharing AP based on a round-robin selecting process.

4. The apparatus of claim 1, wherein coordinating transmission scheduling and transmit power comprises using specific resource units (RUs) for each associated STA.

5. The apparatus of claim 1, wherein both sum data rate and fairness are jointly considered in an optimization objective function.

6. The apparatus of claim 1, further comprising consideration of long-term fairness in reward functions evaluated with respect to time.

7. The apparatus of claim 6, further comprising executing a hierarchical MAB simulation approach in evaluating said reward functions, comprising:
adjusting the target quality-of-service (QoS) parameters in an outer layer of the MAB simulation, between the sharing AP and its associated STA, for every Touter time slot, while balancing data rate maximization and fairness;
performing an inner layer of the MAB simulation, operating at each single time slot, to fine-tune transmission power (P), association selection (A), and MCS, based on adjusted target QoS; and
feeding back performance results from the inner and outer MAB simulations back to inform and refine subsequent coordination decisions.

8. The apparatus of claim 7:
wherein for each time slot, the inner layer of the MAB simulation randomly selects a sharing AP and one of its associated STAs for downlink transmission;
selecting a subset of shared APs based on the context of chosen AP and STA, after which for each AP in the subset, an associated STA along with its transmission power and MCS are tested through simulations to maximize data rate, with the resulting performance metrics being fed back to guide future decisions.

9. The apparatus of claim 8, further comprising introducing a noise term into said hierarchical MAB simulations to encourage exploration during training, wherein the noise term is added, then sampled from a Gaussian distribution to balance between trying new actions and using known strategies.

10. The apparatus of claim 1, further comprising said AP and the other APs, within the WLAN or portion of the WLAN, under this wireless communications protocol receive communications from a central controller that is responsible for coordinating all coordinating APs and performing associated resource management among these APs.

11. The apparatus of claim 10:
wherein said AP and coordinating APs, within the WLAN or portion of the WLAN, follow the instructions provided by the central controller in their scheduling and/or resource allocation, in response to the central controller communicating several elements of control information to said coordinating APs; and
wherein the control information comprises sharing/shared AP information, STA associations, transmission power, MCS selection, and quality-of-service (QoS) requirements for all links and to all APs, whereby all APs within the WLAN or portion of the WLAN are made aware of their individual scheduling and resource management, prior to transmitting downlink signals during a transmit opportunity (TXOP).

12. A station apparatus for communication in a wireless network, the apparatus comprising:
(a) at least one modem coupled to at least one radio-frequency (RF) circuit, with each RF circuit connected to one or multiple antennas;
(b) wherein said station (STA) is configured as a separate STA or as a STA within a multiple-link device (MLD);
(c) a processor of said STA;
(d) a non-transitory memory storing instructions executable by the processor for wirelessly communicating with other STAs on a IEEE 802.11 wireless local area network (WLAN); and
(e) wherein said instructions, when executed by the processor, perform steps of a wireless communications protocol for allowing an increased density of access points (APs) within the WLAN, or portion of the WLAN, using hierarchical reinforcement learning for multiple-AP (MAP) coordinated spatial reuse (CSR), comprising:
(i) wherein said STA operates in the wireless communications protocol as an access point (AP) STA configured for communicating with other STAs, including both AP STAs and non-AP STAS;
(ii) wherein said AP serves as a transmission initiator, as a sharing AP, configured for establishing coordination within a set of APs, wherein each of the other APs on this portion of the WLAN serve as followers, as shared APs;
(iii) performing multiple access point coordination (MAPC) in which the said AP, and other APs within the WLAN or portion of the WLAN, operating with this wireless communications protocol, coordinate with each other to negotiate use of radio resources and specific resource units (RUs) in establishing a transmit power and a modulation and coding scheme (MCS) for each AP associated to each transmission link, for reducing inter-AP contention and congestion, and toward allowing Quality-of-Service (QoS) requirements to be met; and
(iv) determining coordinated-spatial reuse (C-SR) to jointly address a trade off between sum data rate and fairness using an optimization objective function comprising multiple layer reinforcement learning (RL) in a Markov decision process (MDP) characterized by a set of states S, actions A, a reward function R, and transition probabilities Pt, in which a next state of a state space, is determined solely by a current state and action of an action space, to be taken without dependence on past states, and wherein said reward function is evaluated over multiple time periods toward obtaining long-term fairness;
(v) wherein the state space is determined by network topology and the action space having adjustable parameters comprising transmission power P, association selection A, MCS M, and QoS requirements Q, with these joint trade offs performed prior to each transmit opportunity (TXOP); and
(vi) whereby communication resources are fairly coordinated across an increased density of AP stations while controlling operations of followers on this portion of the WLAN.

13. The apparatus of claim 12, wherein selection of said sharing AP is configured for equitable sharing of communication resources between multiple APs based on a round-robin selecting process.

14. The apparatus of claim 12, wherein both sum data rate and fairness are jointly considered in an optimization objective function.

15. The apparatus of claim 12, further comprising consideration of long-term fairness in reward functions evaluated with respect to time.

16. The apparatus of claim 12, further comprising executing a hierarchical MAB simulation approach in evaluating said reward functions, comprising:
adjusting the target quality-of-service (QoS) parameters in an outer layer of the MAB simulation, between the sharing AP and its associated STA, for every Touter time slot, while balancing data rate maximization and fairness;
performing an inner layer of the MAB simulation, operating at each single time slot, to fine-tune transmission power (P), association selection (A), and MCS, based on adjusted target QoS; and
feeding back performance results from the inner and outer MAB simulations back to inform and refine subsequent coordination decisions.

17. The apparatus of claim 16:
wherein for each time slot, the inner layer of the MAB simulation randomly selects a sharing AP and one of its associated STAs for downlink transmission;
selecting a subset of shared APs based on the context of chosen AP and STA, after which for each AP in the subset, an associated STA along with its transmission power and MCS are tested through simulations to maximize data rate, with the resulting performance metrics being fed back to guide future decisions.

18. The apparatus of claim 17, further comprising introducing a noise term into said hierarchical MAB simulations to encourage exploration during training, wherein the noise term is added, then sampled from a Gaussian distribution to balance between trying new actions and using known strategies.

19. The apparatus of claim 12, further comprising said AP and the other APs, within the WLAN or portion of the WLAN, under this wireless communications protocol receive communications from a central controller that is responsible for coordinating all coordinating APs and performing associated resource management among these APs.

20. A method of performing communications in a wireless network, comprising:
(a) performing wireless communications between STAs on a IEEE 802.11 wireless local area network (WLAN), following steps of a wireless communications protocol for allowing an increased density of access points (APs) within the WLAN, or portion of the WLAN, using hierarchical reinforcement learning for multiple-AP (MAP) coordinated-spatial reuse (C-SR), comprising:
(i) wherein one AP serves as a transmission initiator, which operates as a sharing AP, configured for establishing coordination within a set of APs, wherein each of the other APs on this portion of the WLAN serve as followers, operating as shared APs;
(ii) performing multiple access point coordination (MAPC) in which the said AP, and other APs within the WLAN or portion of the WLAN, operating with this wireless communications protocol, coordinate with each other to negotiate use of radio resources in establishing a transmit power and a modulation and coding scheme (MCS) for each AP associated to each transmission link, for reducing inter-AP contention and congestion, and toward allowing Quality-of-Service (QoS) requirements to be met; and
(iii) wherein said modulation and coding scheme (MCS) is determined by a two layer multiple-armed bandit (MAB) process in jointly tuning transmissions;
(iv) determining coordinated-spatial reuse (C-SR) to jointly address a trade off between sum data rate and fairness using an optimization objective function comprising multiple layer reinforcement learning (RL) in a Markov decision process (MDP) characterized by a set of states S, actions A, a reward function R, and transition probabilities Pt, in which a next state of a state space, is determined solely by a current state and action of an action space, to be taken without dependence on past states, and wherein said reward function is evaluated over multiple time periods toward obtaining long-term fairness;
(v) wherein the state space is determined by network topology and the action space having adjustable parameters comprising transmission power P, association selection A, MCS M, and QoS requirements Q, with these joint trade offs performed prior to each transmit opportunity (TXOP); and
(vi) whereby communication resources are fairly coordinated across an increased density of AP stations while controlling operations of followers on this portion of the WLAN.
